(19) United States
(12) Patent Application Publication
(10) Pub. No.: US 2014/0175352 A1
(43) Pub. Date: Jun. 26, 2014

(54) HAMMER WITH LINEARLY ADJUSTABLE RATCHETING CLAW

(71) Applicant: Scott L. Smith, Jacksonville, FL (US)

(72) Inventor: Scott L. Smith, Jacksonville, FL (US)

(21) Appl. No.: 14/137,916

(22) Filed: Dec. 20, 2013

Related U.S. Application Data
(60) Provisional application No. 61/739,940, filed on Dec. 20, 2012.

(51) Int. Cl. B25D 1/04

(52) U.S. Cl. CPC B25D 1/04
USPC 254/26 R

(57) ABSTRACT

A hammer has a claw assembly that is moveable relative to the head of the hammer so as to improve leverage and range of prying for nail removal. The ratcheting mechanism may be automatic or manual.

### RELATED APPLICATION

This application is a non-provisional and claims the benefit of priority of U.S. Provisional Application No. 61/739,940 filed Dec. 20, 2012, the entire contents of which are incorporated herein and made a part hereof.

### FIELD OF THE INVENTION

This invention relates to claw hammers, and, more particularly to a claw hammer with a claw that is moveable relative to the head of the hammer so as to improve leverage and range of prying for nail removal.

### BACKGROUND

As is well known, a conventional claw hammer is a tool primarily used for pounding nails into or extracting nails from some other object. Generally, a claw hammer is associated with woodworking but is not limited to use with wood products.

A conventional claw hammer 10 is illustrated in FIG. 1. From a profile, it roughly resembles the letter “T”. The handle 15 is the long vertical part. The head assembly 20 includes a striking head 25 and a curved two-prong claw 30 opposite the striking head. The claw 30 curves downward (i.e., towards the handle) and splits in the middle forming a “V” shape gap 35. The claw increases in thickness from the free end to the intersection with the handle 15. This gap 35 is the part of the claw 30 of the hammer 10 that is commonly used for extracting nails from wood. The curved claw 30 in conjunction with the handle 15 is used to gain leverage when extracting a nail.

The curvature and length of the claw 30 varies among hammers. By way of example, the claw of a framing hammer may feature less curvature than the claw curvature of a finishing hammer and therefore does not have as much leverage for removing nails. While claws are useful for fully extracting short nails in one fluid motion, long nails pose challenges. A claw may not have sufficient length and range of motion to fully extract the nail. The claw may be adequate to partially remove the nail. A user must then struggle to extract the remaining embedded portion of the nail, such as by applying another tool, e.g., pliers, and considerable pulling force or by applying a board, such as a 2×4, to raise the height of the fulcrum point. Although a hammer could be provided with an extremely long curved claw sufficient to extract even the longest nail, such a hammer would be extremely cumbersome to wield.

The invention is directed to overcoming one or more of the problems and solving one or more of the needs as set forth above.

### SUMMARY OF THE INVENTION

To solve one or more of the problems set forth above, in an exemplary implementation of the invention, a hammer includes a linearly adjustable ratcheting claw. The claw assembly includes a claw with a v-shaped groove for engaging a nail. The claw assembly is movable linearly relative to the striking head of the hammer. A channel is configured to receive and glide along an engaging portion of the handle. A ratcheting mechanism causes a pawl to engage and disengage a rack of spaced apart teeth. The pawl and rack regulate linear movement of the claw assembly. A spring compartment in the handle contains a compression spring that urges the claw assembly towards its topmost (extended) position. A nail head lever is attached to the concave side of the claw. The lever extends outwardly from the handle to a point past the vertex of the v-groove. During extraction of a nail using the claw, the head of the nail may bear against the lever. The lever may be attached with a pivot pin and biased to pivot towards an abutting nail head. The lever may also be operably coupled to a linkage coupled to a pawl. The linkage may advance the pawl to allow retraction of the claw assembly when the lever is pushed by a nail. While the pawl locks the claw assembly in place, a permanent magnet at the apex of the handle helps to secure the claw assembly.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides profile and perspective views that conceptually illustrate a prior art conventional claw hammer; and

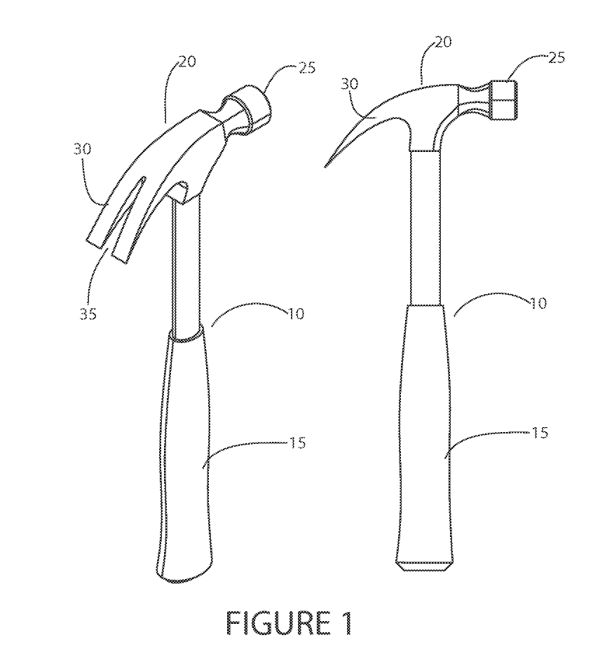

FIG. 2 provides a perspective view of an exemplary embodiment of a hammer with a linearly adjustable ratcheting claw according to principles of the invention.

FIG. 3 provides a perspective view of an exemplary embodiment of a portion of a hammer, with the linearly adjustable ratcheting claw removed, according to principles of the invention.

FIG. 4 provides a perspective view of another exemplary embodiment of a hammer with a linearly adjustable ratcheting claw according to principles of the invention.

FIG. 5 provides a perspective view of another exemplary embodiment of a hammer with a linearly adjustable ratcheting claw according to principles of the invention.

FIG. 6 provides a perspective view of an exemplary embodiment of a claw assembly for a hammer with a linearly adjustable ratcheting claw according to principles of the invention.

FIG. 7 provides a perspective view of another exemplary embodiment of a hammer with a linearly adjustable ratcheting claw according to principles of the invention.

FIG. 8 provides a perspective view of another exemplary embodiment of a hammer with a linearly adjustable ratcheting claw in a retracted position according to principles of the invention.

FIG. 9 schematically illustrates an exemplary embodiment of a ratcheting rack and pawl assembly for a hammer with a linearly adjustable ratcheting claw according to principles of the invention.

FIG. 10 provides a perspective view of another exemplary embodiment of a hammer with a linearly adjustable ratcheting claw in a retracted position according to principles of the invention.

FIG. 11 provides a perspective view of an exemplary embodiment of a claw assembly for a hammer with a linearly adjustable ratcheting claw according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

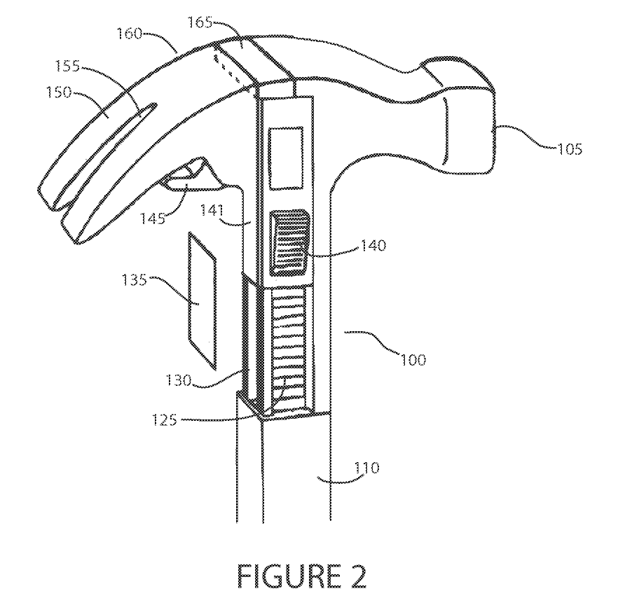

Referring now to FIG. 2, a perspective view of an exemplary embodiment of a hammer 100 with a linearly adjustable ratcheting claw assembly 160 according to principles of the invention is shown. The claw assembly 160 includes a claw 150 with a v-shaped groove 155 for engaging a nail. The claw assembly 160 is movable linearly relative to the striking head 105 of the hammer. A channel 141 is configured to receive and glide along an engaging portion of the handle. A ratcheting mechanism, which includes a manual switch 140, causes a pawl to engage and disengage a rack 125 of spaced apart teeth. The pawl and rack regulate linear movement of the claw assembly 160.

A spring compartment 130 in the handle 110 contains a compression spring 131 that urges the claw assembly towards its topmost position, as shown in FIG. 2. The spring may be a coil, leaf or other type of biasing means that resists compression. A removable cover 135 closes the opening of the spring compartment 130. The cover 135 fits flush against the opening so as to avoid interference with up and down motion of the claw assembly 160.

A nail head lever 145 is attached to the concave side of the claw 150. The lever 145 extends outwardly from the handle to a point past the vertex of the v-groove. During extraction of a nail using the claw 150, the head of the nail may bear against the lever 145. The lever 145 may be attached with a pivot pin and biased to pivot towards an abutting nail head. The lever 145 may also be operably coupled to a linkage coupled to a pawl. The linkage may advance the pawl to allow retraction of the claw assembly 160 when the lever 145 is pivoted by an advancing nail.

A permanent magnet 165 is attached at the apex of the handle 110. The magnet 165 is stationary. The claw assembly 160 is comprised of a material to which the magnet 165 is magnetically attracted (e.g., a ferrous material). When the claw assembly 160 is in the fully raised (i.e., topmost) position as shown in FIG. 2, the magnet 165 helps securely hold the claw assembly 160. Rattling, jostling and unintended movement of the claw assembly 160 are alleviated by the magnet 165.

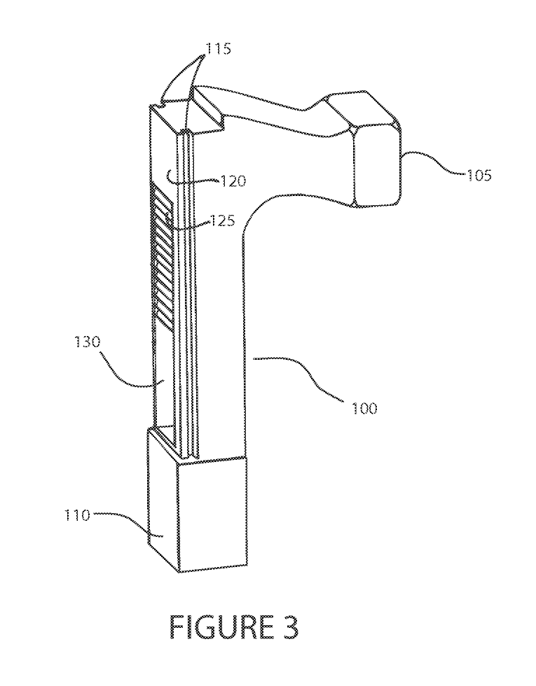

FIG. 3 provides a perspective view of an exemplary embodiment of a handle and striking portion of a hammer 100, with the linearly adjustable ratcheting claw removed, according to principles of the invention. The claw assembly abuts side 120 and is movable linearly relative to the striking head 105 of the hammer. Channels 115 are provided to receive flanged ends (i.e., rails) of a channel of the claw assembly, which glides along an engaging portion of the handle. A rack 125 of spaced apart teeth for the ratcheting action. Notice that the rack is positioned differently than in the embodiment of FIG. 2. The particular location of the rack is not important so long as it enables ratcheting control of linear movement of the claw assembly.

A spring compartment 130 in the handle 110 contains a compression spring 131 that urges the claw assembly towards its topmost position, as discussed above in relation to FIG. 2. The spring may be a coil, leaf or other type of biasing means that resists compression.

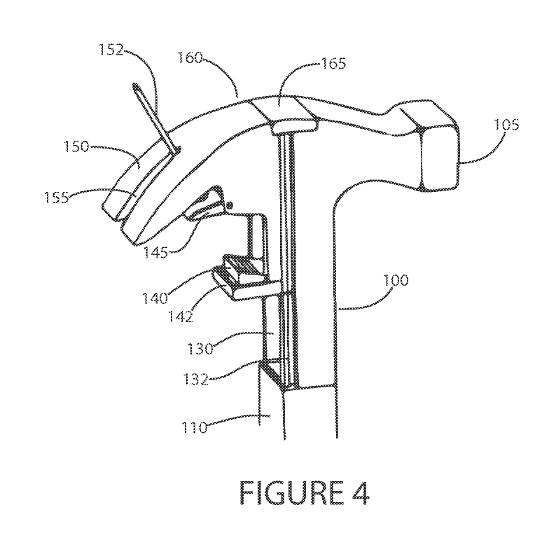

Referring now to FIG. 4, a perspective view of another exemplary embodiment of a hammer 100 with a linearly adjustable ratcheting claw assembly 160 according to principles of the invention is shown. As with the embodiment described above, the claw assembly 160 includes a claw 150 with a v-shaped groove 155 for engaging a nail. The claw assembly 160 is movable linearly relative to the striking head 105 of the hammer. A channel of the claw assembly with flanged ends is configured to receive and glide along an engaging portion of the handle. The flanged ends slide within channels 132 in the handle 110. A ratcheting mechanism, which includes a manual switch 140 and a cantilevered support 142, causes a pawl to engage and disengage a rack of spaced apart teeth. The pawl and rack regulate linear movement of the claw assembly 160.

A spring compartment 130 in the handle 110 contains a compression spring 131 that urges the claw assembly towards its topmost position, as shown in FIG. 4. The spring may be a coil, leaf or other type of biasing means that resists compression.

A nail head lever 145 is attached to the concave side of the claw 150. The lever 145 extends outwardly from the handle to a point past the vertex of the v-groove. During extraction of a nail using the claw 150, the head of the nail 152 may bear against the lever 145. The lever 145 may be attached with a pivot pin and biased to pivot towards the abutting nail head. The lever 145 may also be operably coupled to a linkage coupled to a pawl. The linkage may advance the pawl to allow retraction of the claw assembly 160 when the lever 145 is pivoted by an advancing nail.

A permanent magnet 165 is attached at the apex of the handle 110. The magnet 165 is stationary. The claw assembly 160 is comprised of a material to which the magnet 165 is magnetically attracted (e.g., a ferrous material). When the claw assembly 160 is in the fully raised (i.e., topmost) position as shown in FIG. 4, the magnet 165 helps securely hold the claw assembly 160. Rattling, jostling and unintended movement of the claw assembly 160 are alleviated by the magnet 165.

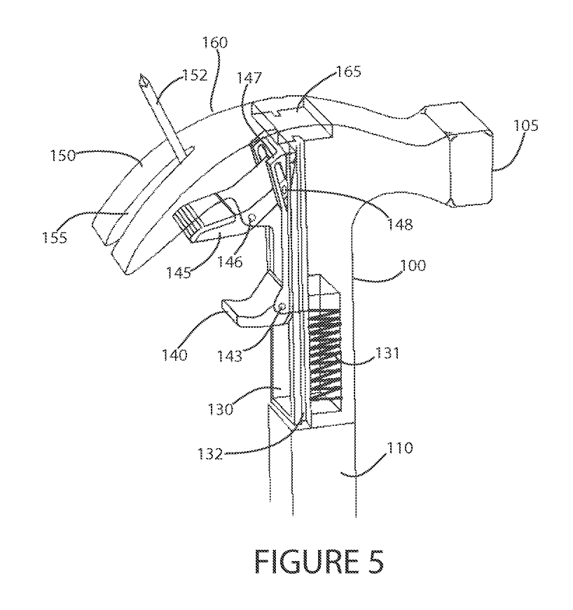

FIG. 5 provides a perspective view of another exemplary embodiment of a hammer 100 with a linearly adjustable ratcheting claw assembly 160 according to principles of the invention. Certain portions of the hammer are shown transparent, to conceptually illustrate components that would otherwise be hidden by the solid structures. The claw assembly 160 includes a claw 150 with a v-shaped groove 155 for engaging a nail 152. The claw assembly 160 is movable linearly relative to the striking head 105 of the hammer. A flanged channel is configured to engage and glide in channels 132 along an engaging portion of the handle. A ratcheting mechanism which includes a manual switch 140 (e.g., lever or slide) that causes a pawl to engage and disengage a rack of spaced apart teeth. The pawl and rack regulate linear movement of the claw assembly 160.

A spring compartment 130 in the handle 110 contains a compression spring 131 that urges the claw assembly towards its topmost position, as shown in FIG. 2. The spring may be a coil, leaf or other type of biasing means that resists compression. A removable cover 135 closes the opening of the spring compartment 130. The cover 135 fits flush against the opening so as to avoid interference with up and down motion of the claw assembly 160.

A nail head lever 145 is attached to the concave side of the claw 150. The lever 145 extends outwardly from the handle to a point past the vertex of the v-groove. During extraction of a nail using the claw 150, the head of the nail may bear against the lever 145. The lever 145 may be attached with a pivot pin 146 and biased to pivot towards an abutting nail head. The lever 145 may also be operably coupled to a guide rail 147 by guide pins 148. Pivoting movement of the lever 145 may engage and release the pawl to allow locking and refraction of the claw assembly 160.

A permanent magnet 165 is attached at the apex of the handle 110. The magnet 165 is stationary. The claw assembly 160 is comprised of a material to which the magnet 165 is magnetically attracted (e.g., a ferrous material). When the claw assembly 160 is in the fully raised (i.e., topmost) position as shown in FIG. 2, the magnet 165 helps securely hold the claw assembly 160. Rattling, jostling and unintended movement of the claw assembly 160 are alleviated by the magnet 165.

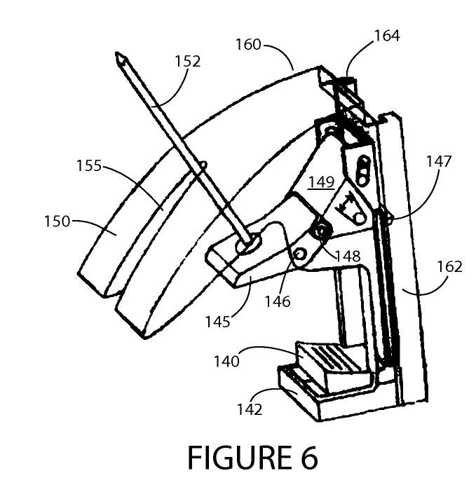

FIG. 6 provides a perspective view of an exemplary embodiment of a claw assembly 160 for a hammer with a linearly adjustable ratcheting claw according to principles of the invention. The claw assembly 160 includes a claw 150 with a v-shaped groove 155 for engaging a nail 152. The claw assembly 160 is movable linearly relative to the striking head 105 of the hammer. Flanged channels 162, 164 are configured to engage and glide in channels along an engaging portion of a handle. A ratcheting mechanism which includes a manual switch 140 that causes a pawl 147 to engage and disengage a rack of spaced apart teeth. The pawl 147 and rack regulate linear movement of the claw assembly 160.

A nail head lever 145 is attached to the concave side of the claw 150. The lever 145 extends outwardly from the handle to a point past the vertex of the v-groove. During extraction of a nail using the claw 150, the head of the nail may bear against the lever 145. The lever 145 may be attached with a pivot pin 146 and biased to pivot towards an abutting nail head. The lever 145 may also be operably pivotally coupled to a second lever 149 configured to pivot in a direction opposite to the pivoting direction of the primary lever 145. The secondary lever 149 may be spring biased, such as with a torsion spring. Pivoting movement of the primary lever 145 may engage and release the pawl to allow locking and refraction of the claw assembly 160.

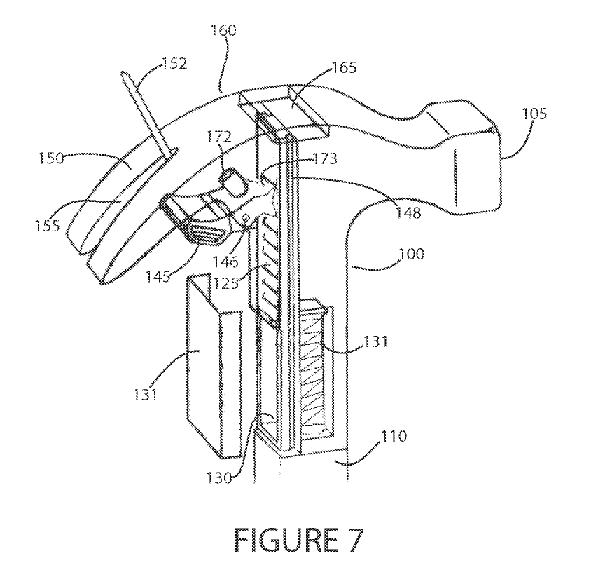

FIG. 7 provides a perspective view of another exemplary embodiment of a hammer with a linearly adjustable ratcheting claw according to principles of the invention. The claw assembly 160 includes a claw 150 with a v-shaped groove 155 for engaging a nail 152. The claw assembly 160 is movable linearly relative to the striking head 105 of the hammer. A flanged channel is configured to engage and glide in channels 148 along an engaging portion of the handle. A ratcheting mechanism causes a pawl 173 to engage and disengage a rack 125 of spaced apart teeth. The pawl 173 and rack 125 regulate linear movement of the claw assembly 160.

A spring compartment 130 in the handle 110 contains a compression spring 131 that urges the claw assembly towards its topmost position, as shown in FIG. 7. The spring 131 may be a coil, leaf or other type of biasing means that resists compression. A removable cover 131 closes the opening of the spring compartment 130. The cover 131 fits flush against the opening so as to avoid interference with up and down motion of the claw assembly 160.

A nail head lever 145 is attached to the concave side of the claw 150. The lever 145 extends outwardly from the handle to a point past the vertex of the v-groove. During extraction of a nail using the claw 150, the head of the nail may bear against the lever 145. The lever 145 may be attached with a pivot pin 146 and magnetically biased to pivot to a locking position. A magnet 172 is provided to urge the lever and pawl into a locking position. Pivoting movement of the lever 145 may engage and release the pawl 173 to allow locking and retraction of the claw assembly 160.

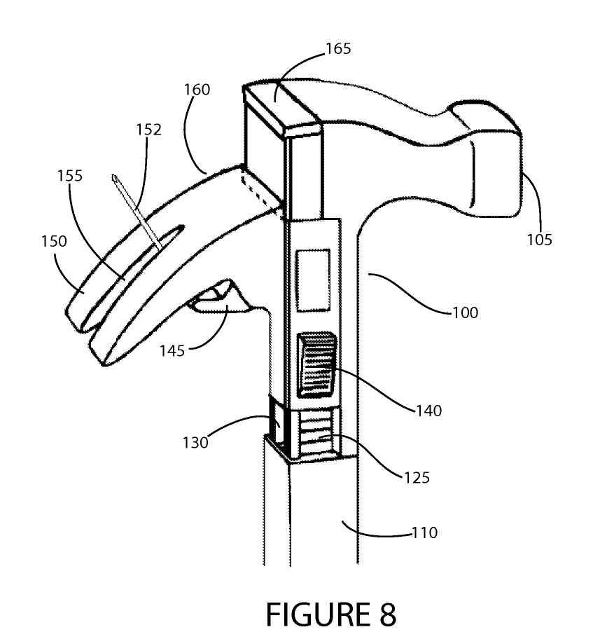

FIG. 8 provides a perspective view of another exemplary embodiment of a hammer 100 with a linearly adjustable ratcheting claw assembly 160 in a retracted position according to principles of the invention. The hammer 100 is substantially the same as the embodiment in FIG. 2. The claw assembly 160 is shown moved linearly relative to the striking head 105 of the hammer to an extracting position. The distance between the fulcrum at the magnet 165 and the engaged nail 152 has been substantially increased. This distance provides increased leverage and range of motion to extract a nail 152. After the nail is extracted, the pawl may be released (i.e., disengaged from the rack) and the claw assembly may be returned to its fully extended position as shown in FIG. 2.

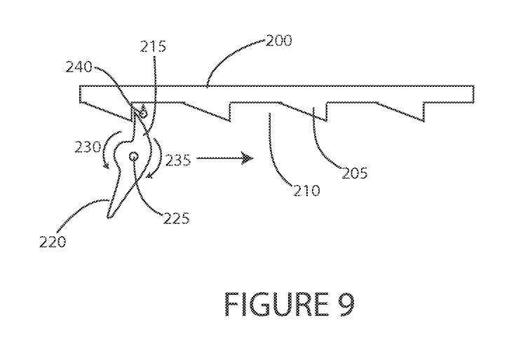

FIG. 9 schematically illustrates an exemplary embodiment of a ratcheting rack 200 and pawl 215 assembly for a hammer with a linearly adjustable ratcheting claw according to principles of the invention. The ratchet allows continuous linear motion in only one direction (i.e., the retracting direction) while preventing motion in the opposite direction (the extended direction), until a pawl 215 is released. The ratchet includes a linear rack 200 with teeth 205, and a pivoting, springloaded finger called a pawl 215 that engages the teeth. The teeth 205 are uniform but asymmetrical, with each tooth having a moderate slope on one edge and a much steeper slope on the other edge. When the pawl is moving in the unrestricted (i.e., retracting) direction, the pawl 215 easily slides up and over the gently sloped edges of the teeth, with a spring forcing it (possibly with an audible “click”) into the depression 210 between the teeth as it passes the tip of each tooth. When the pawl 215 moves in the opposite (backward) direction, however, the pawl will catch against the steeply sloped edge of the first tooth it encounters, thereby locking it against the tooth and preventing any further motion in that direction. The pawl's range of rotation is controllably restricted to ensure catching until released, while allowing pivoting for retracting linear movement. By way of example and not limitation a stop 240 may prevent rotation of the pawl in one direction 235, until the stop is moved, while permitting substantial rotation in the opposite direction 230. In one embodiment, the pawl 215 is coupled to a lever 220 acted upon, directly or indirectly, by the head of a nail. The head of a nail pushing against the lever 220 causes the pawl 215 to move in the retracting direction along the rack 200.

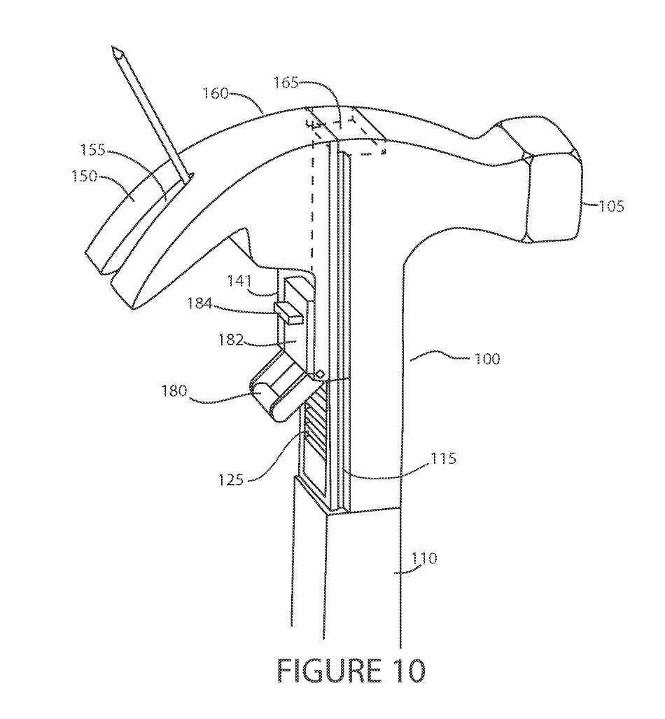

FIG. 10 provides a perspective view of another exemplary embodiment of a hammer with a linearly adjustable ratcheting claw according to principles of the invention. The claw assembly 160 includes a claw 150 with a v-shaped groove 155 for engaging a nail 152. The claw assembly 160 is movable linearly relative to the striking head 105 of the hammer. A flanged channel is configured to engage and glide in channels 148 along an engaging portion of the handle. A ratcheting mechanism with a pivoting lever 180, a ratchet body and a ratchet switch 184 causes a pawl to engage and disengage a rack 125 of spaced apart teeth. The pawl and rack 125 regulate linear movement of the claw assembly 160. The switch 184 affects the angle of the pawl relative to the engaged teeth of the rack 125 to allow or resist movement in one direction or another. Thus, in this embodiment, movement in each direction (i.e., up/down) is controlled by ratcheting.

Alternatively, the switch 184 may have an engaged position and a free position. In the engaged position, the ratchet causes the claw assembly to move linearly away from the striking head 105 of the hammer. In the free position, the pawl is disengaged and the claw assembly may be slid linearly in either direction.

A nail head lever 145 is attached to the concave side of the claw 150. The lever 145 extends outwardly from the handle to a point past the vertex of the v-groove. During extraction of a nail using the claw 150, the head of the nail may bear against the lever 145. The lever 145 may be attached with a pivot pin 146 and magnetically biased to pivot to a locking position. A magnet 172 is provided to urge the lever and pawl into a locking position. Pivoting movement of the lever 145 may engage and release the pawl 173 to allow locking and retraction of the claw assembly 160.

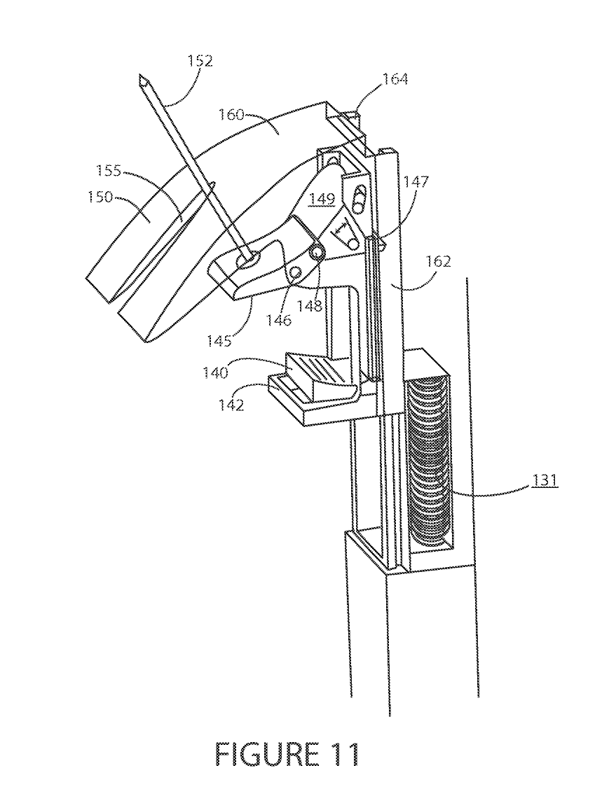

FIG. 11 provides a perspective view of an exemplary embodiment of a claw assembly 160 for a hammer with a linearly adjustable ratcheting claw according to principles of the invention. The claw assembly 160 includes a claw 150 with a v-shaped groove 155 for engaging a nail 152. The claw assembly 160 is movable linearly relative to the striking head 105 of the hammer. Flanged channels 162, 164 are configured to engage and glide in channels along an engaging portion of a handle. A ratcheting mechanism which includes a manual switch 140 that causes a pawl 147 to engage and disengage a rack of spaced apart teeth. The pawl 147 and rack regulate linear movement of the claw assembly 160.

A nail head lever 145 is attached to the concave side of the claw 150. The lever 145 extends outwardly from the handle to a point past the vertex of the v-groove. During extraction of a nail using the claw 150, the head of the nail may bear against the lever 145. The lever 145 may be attached with a pivot pin 146 and biased to pivot towards an abutting nail head. The lever 145 may also be operably pivotally coupled to a second lever 149 configured to pivot in a direction opposite to the pivoting direction of the primary lever 145. The secondary lever 149 may be spring biased, such as with a torsion spring. Pivoting movement of the primary lever 145 may engage and release the pawl to allow locking and refraction of the claw assembly 160.

A spring compartment 130 in the handle 110 contains a compression spring 131 that urges the claw assembly towards its topmost position, as discussed above in relation to FIG. 2. The spring may be a coil, leaf or other type of biasing means that resists compression.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A hammer with a claw assembly that is moveable relative to the head of the hammer so as to improve leverage and range of prying for nail removal, as shown in the figures and described above.
